(19) United States
(12) Patent Application Publication
(10) Pub. No.: US 2004/0178393 A1
(43) Pub. Date: Sep. 16, 2004

(54) Conductive paste, method of controlling viscosity thereof and electronic component using the same

(75) Inventors: Hiroyuki Kurihara, Osaka-shi (JP); Ichiro Nakamura, Kusatsu-shi (JP); Taketsugu Ogura, Shiga-ken (JP); Motohiro Shimizu, Kusatsu-shi (JP)

Correspondence Address: DICKSTEIN SHAPIRO MORIN & OSHINSKY, LLP, 1177 Avenue of the Americas, New York, NY, 10036, US

(73) Assignee: Murata Manufacturing Co., Ltd.

(21) Appl. No.: 10/808,453

(22) Filed: Mar. 25, 2004

Related U.S. Application Data
(62) Division of application No. 10/079,094, filed on Feb. 19, 2002.

(30) Foreign Application Priority Data
Feb. 19, 2001 (JP) 2001-042156

(51) Int. Cl. H01B 1/00

(52) U.S. Cl. 252/500

(57) ABSTRACT

A conductive paste having a desired viscosity which does not change with time, and having stable viscosity characteristics, and an electronic component formed using the conductive paste are provided, the conductive paste including a conductive powder, an organic vehicle, at least one compound selected from the group consisting of a compound which has a tertiary amine structure and which is dissolved into the organic vehicle, and a compound which has a heterocyclic structure including nitrogen but not including sulfur and which is dissolved into the organic vehicle.

This is a division of application Ser. No. 10/079,094, filed Feb. 19, 2002, which is hereby incorporated herein by reference.

### BACKGROUND OF THE INVENTION

1. Field of the Invention

The present invention relates to a conductive paste used for forming an electrode of an electronic component, to a method of controlling the viscosity of the conductive paste, and to an electronic component including an electrode formed using the conductive paste.

2. Description of the Related Art

Regarding the steps of manufacturing electronic components, for example, monolithic capacitors and ceramic multilayer substrates, one example of the methods for forming electrode is a method in which an element portion made of ceramic, etc., is coated with a conductive paste containing a powder of Pt, Ag, Ni, Cu, Al, W, or the like as a conductive component and heat treatment is performed, so as to produce the electrode.

In the case where the electrode of the electronic component is formed by using the aforementioned method, in order to realize miniaturization and high precision of the electronic component, a uniform and thin coating of the conductive paste must be applied to the element portion during the steps of manufacture. On this account, a conductive paste having a desired viscosity, which does not change with time and which is therefore stable, must be used.

Examples of conventional methods for stabilizing the viscosity of a conductive paste include, for example, as disclosed in Japanese Unexamined Patent Application Publication No. 10-41179, a method in which a material, e.g., stearic acid and palmitic acid, is added into the conductive paste. According to such a method, it is believed that since polycondensated organic vehicles in the conductive paste are hydrolyzed, an increase in the viscosity of the conductive paste can be inhibited.

However, regarding the aforementioned conventional method, there are two problems:

(1) Although the increase in viscosity over time of the produced conductive paste can be inhibited, the viscosity immediately after production cannot be reduced and, therefore, conductive pastes having desired viscosities cannot be produced; and

(2) It is believed that solid matter other than the conductive powder maybe present in the conductive paste depending on the solvents used. In such a case, regarding the electronic component including electrodes formed by using the aforementioned conductive paste, defects, such as short-circuit defects, may occur and, therefore, the yield may be reduced.

### SUMMARY OF THE INVENTION

The present invention was made in order to overcome the aforementioned problems. Accordingly, it is an object of the present invention to provide a conductive paste having a desired viscosity, which does not change with time, and having stable viscosity characteristics, and to provide an electronic component formed using the conductive paste.

It has been found that the reason for the high viscosity of the conductive paste immediately after production is that the surface of the conductive powder is covered with hydroxyl groups derived from water adsorbed by the conductive powder, and the hydroxyl groups and hydrogen atoms of organic resins in the organic vehicle make hydrogen bonds and, therefore, a three-dimensional network of the organic resins with metals (conductive powders) therebetween is formed.

It has also been found that the reason for the increase in viscosity over time is that some portions in a slightly oxidized state are present on the surfaces of the metals (conductive powders), and since these portions in the oxidized state are in an electron-deficient state, unshared electron pairs of oxygen in the organic resins constituting the organic vehicle are bonded with the aforementioned portions and, therefore, a three-dimensional network of the organic resins with metals therebetween is formed gradually.

According to a first aspect of the present invention, a conductive paste is provided which solves the problems of high viscosity of the conductive paste immediately after production and an increase in viscosity over time. The conductive paste contains (a) a conductive powder, (b) an organic vehicle, and (c) at least one compound selected from the group consisting of a compound, which has a tertiary amine structure and which is dissolved into the aforementioned organic vehicle, and a compound, which has a heterocyclic structure including nitrogen but not including sulfur and which is dissolved into the aforementioned organic vehicle.

Regarding the conductive paste according to the present invention, in order to control the viscosity, at least one compound selected from the group consisting of a compound which has a tertiary amine structure and which is dissolved into the organic vehicle and a compound which has a heterocyclic structure including nitrogen but not including sulfur and which is dissolved into the organic vehicle is added. That is, when the viscosity immediately after production is high, the compound, which has a tertiary amine structure and which is dissolved into the aforementioned organic vehicle, is added, and when the viscosity increases with time after production, the compound, which has a heterocyclic structure including nitrogen but not including sulfur and which is dissolved into the organic vehicle, is added. As a consequence, a conductive paste having a desired viscosity in response to the viscosity characteristics of the conductive paste can be produced, and in addition to this, the desired viscosity can be maintained for a long time.

Preferably, regarding the conductive paste according to the present invention, the aforementioned conductive powder contains at least one material selected from the material group consisting of Pt, Ag, Ni, Cu, Al, and W or an alloy including at least one material selected from the aforementioned material group.

In the present invention, although the kind of conductive powder is not specifically limited, by using the conductive powder containing at least one material selected from the material group consisting of Pt, Ag, Ni, Cu, Al, and W or an alloy including at least one material selected from the aforementioned material group, an electrode having sufficient electrical conductivity can be formed reliably.

Preferably, regarding the conductive paste according to the present invention, the aforementioned organic vehicle contains at least one compound selected from the group consisting of compounds having a cellulose structure, compounds having a cellulose ester structure, and compounds having a cellulose ether structure.

By using the organic vehicle containing at least one compound selected from the group consisting of compounds having a cellulose structure, compounds having a cellulose ester structure, and compounds having a cellulose ether structure, since the viscosity required for coating can be ensured at a reduced content of the organic vehicle, the content of the conductive powder in the conductive paste can be increased.

According to a second aspect of the present invention, an electronic component including an electrode formed by using the conductive paste according to the present invention is provided.

When the conductive paste according to the present invention is used, since an electrode having a uniform and reduced thickness can be formed reliably, a miniaturized electronic component having high performance and high reliability can be provided.

Preferably, regarding the electronic component according to the present invention, the aforementioned electrode is formed by printing the aforementioned conductive paste and sintering the printed conductive pattern.

When the electrode is formed by printing the conductive paste according to the present invention and sintering, an electrode having a uniform and reduced thickness can be formed with ease and reliability and, therefore, a miniaturized electronic component having high performance and high reliability can be produced without especially complicated manufacturing steps.

Preferably, regarding the electronic component according to the present invention, the thickness of the primary part of the aforementioned electrode is 1 mm or less.

When the thickness of the electrode to be formed is reduced to 1 mm or less, it is especially required that a conductive paste having a desired viscosity be used. In such a case, by using the conductive paste according to the present invention, the electronic component provided with the electrode having a primary part with a thickness of 1 mm or less can be reliably produced.

The electronic component according to the present invention formed by using the conductive paste according to the present invention may be a monolithic ceramic capacitor.

That is, the monolithic ceramic capacitor having an internal electrode made of the conductive paste can be formed by printing the conductive paste on a ceramic green sheet, stacking the plurality of the ceramic green sheet having the printed conductive pattern for the internal electrode, and sintering them.

The monolithic ceramic capacitor is an electronic component, in which, especially, the number of laminated layers of internal electrodes and ceramic layers must be increased in order to meet the demands for miniaturization and large capacitance. However, when the electrode is formed by using the conductive paste according to the present invention, a miniaturized monolithic ceramic capacitor having large capacitance and high reliability can be produced, in which the electrode has a reduced and uniform thickness, and defects, such as delamination, are unlikely to accompany the increase in the number of the laminated layers.

According to a third aspect of the present invention, a method of controlling the viscosity of a conductive paste including a conductive powder and an organic vehicle is provided. The method comprises adding to the conductive paste at least one compound selected from the group consisting of a compound which has a tertiary amine structure and which can be dissolved into the organic vehicle, and adding to the conductive paste a compound which has a heterocyclic structure including nitrogen but not including sulfur and which can be dissolved into the organic vehicle.

Preferably, the compound which has a tertiary amine structure and which can be dissolved into the organic vehicle is at least one selected from the group consisting of N,N′,N′-tris(2-hydroxyethyl)-N-alkyl-1, 3-diaminopropane, triethylamine, and trimethylamine.

The compound which has a heterocyclic structure including nitrogen but not including sulfur and which can be dissolved into the organic vehicle may preferably be at least one selected from the group consisting of benzotriazole, quinoline, isoquinoline, carbazole, indole, and 1,8-diazaphenanthrene.

The conductive powder may preferably comprise at least one material selected from the material group consisting of Pt, Ag, Ni, Cu, Al, and W or an alloy including at least one material selected from the material group.

The organic vehicle may preferably comprise at least one resin compound selected from the group consisting of compounds having a cellulose structure, compounds having a cellulose ester structure, and compounds having a cellulose ether structure.

### DETAILED DESCRIPTION OF EMBODIMENTS OF THE INVENTION

In the application of the present invention, although the kind of conductive powder constituting the conductive paste is not specifically limited, generally, for example, a conductive powder containing at least one material selected from the material group consisting of Pt, Ag, Ni, Cu, Al, and W or an alloy including at least one material selected from the aforementioned material group, is suitable.

Furthermore, oxide coatings, etc., may be applied on the surfaces of these conductive powders, and other additives maybe added. Although the diameters of these conductive powders are not specifically limited, from the viewpoint of miniaturization and reduction of the layer thickness of a lamination type electronic component, the conductive powder preferably has a particle diameter of 1 mm or less, and more preferably, has a particle diameter of 0.5 mm or less. In general, when the particle diameter of the conductive powder to be used is reduced, the viscosity control of the conductive paste becomes more difficult and, therefore, the utility of the present invention increases.

The organic vehicle used in the present invention is one in which an organic resin is dissolved into a solvent. The kinds of organic resin and solvent used in the present invention are not specifically limited. However, when the electronic component is manufactured by using the conductive paste, in the case where the organic resin is heated and decomposed, it is desirable to use an organic resin, which ensures that the viscosity required for the coating can be provided at a reduced content. In such a case, it is preferable to use cellulose esters, such as, cellulose acetate, cellulose ethers, such as, methyl cellulose and ethyl cellulose, and other resins having a cellulose structure. The compounding ratio (parts by weight) of the conductive powder to the organic vehicle is preferably 20:80 to 80:20 in consideration of the balance between the conductivity and moldability. The conductive paste according to the present invention is especially applied to the so-called sintering type conductive paste to be baked at a temperature (for example, 500° C. to 1300° C.) at which substantially no organic component remains in the electrode formed from the conductive paste.

In the present invention, the chemical structure, which the material to be added for control and stabilization of the viscosity of the conductive paste must have, varies depending on the relationship between the initial viscosity (the viscosity immediately after production) and the viscosity required of the conductive paste during use.

That is, some conductive pastes have high viscosities immediately after production, and therefore, it is difficult to use those pastes without further treatment, and some conductive pastes have viscosities which increase with time after production. The materials which should be added to each of the conductive pastes having high viscosities immediately after production and conductive pastes having viscosities which increase with time after production, will be separately described below.

<Regarding Additives in the Case where the Viscosity Immediately After Production is High>

The reason for the high viscosity of the conductive paste immediately after production is that the surface of the conductive powder is covered with hydroxyl groups derived from water adsorbed by the conductive powder, and the hydroxyl groups and hydrogen atoms of the organic resins in the organic vehicle make hydrogen bonds and, therefore, a three-dimensional network of the organic resins with metals (conductive powders) therebetween is formed.

Therefore, by adding a material having a structure which accepts a hydrogen atom included in the organic resin, that is, a Brönsted base structure, the formation of the three-dimensional network of the organic resins with metals (conductive powders) therebetween is inhibited or prevented, so that the viscosity of the conductive paste immediately after production can be reduced. That is, since the aforementioned additive having the Brönsted base structure inhibits the aforementioned hydrogen bond between the hydroxyl group on the surface of the conductive powder and the organic resin in the organic vehicle by bonding with the hydrogen atom of the organic resin in the organic vehicle, the viscosity of the conductive paste immediately after production can be reduced.

Examples of the additives, which meet the aforementioned requirements, include those having a structure including a strongly basic hydroxyl group and those having a structure including a nitrogen atom. However, those having excessively strong basicity are not preferable because they may decompose organic resins, etc.

From the aforementioned viewpoint, a material having a tertiary amine structure is required among the materials which are Brönsted bases with respect to the organic resin in the aforementioned organic vehicle.

Examples of the materials having a tertiary amine structure and which are suitable for the use in the present invention include, for example, N,N′,N′-tris(2-hydroxyethyl)-N-alkyl-1,3-diaminopropane represented by the following Chemical formula 1, and in addition to this, triethylamine, trimethylamine, etc. In order to sufficiently exhibit the aforementioned effects, the contents of theses additives are preferably 0.05 to 10 parts by weight, and more preferably, are 0.1 to 3 parts by weight relative to 100 parts by weight of the total of the conductive powder and the organic vehicle.

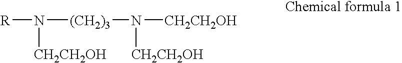

(wherein R denotes an alkyl group)

<Regarding additives in the case where the viscosity increases with time after production>

The reason for the increase in viscosity with time is that some portions in a slightly oxidized state are present on the surfaces of the metals (conductive powders), and since these portions in the oxidized state are in an electron-deficient state, unshared electron pairs of oxygen in the organic resins constituting the organic vehicle are bonded with the electron-deficient portions and, therefore, a three-dimensional network of the organic resins with metals therebetween is formed gradually.

Consequently, by adding a material having a structure which supplies an electron to the electron-deficient portion in the conductive powder, that is, a Lewis base structure, the gradual formation of the three-dimensional network of the organic resins with metals (conductive powders) therebetween is inhibited or prevented, so that the time-varying increase of the viscosity of the conductive paste can be prevented. That is, the compound having the Lewis base structure prevents the organic resins in the organic vehicle from bonding with the metals (conductive powders) by supplying the electron to the aforementioned metal in an electron-deficient state, and therefore, performs function of preventing the time-varying increase of the viscosity.

Examples of the additives, which meet the aforementioned requirements, include those having a structure including a strongly basic hydroxyl group and those having a structure including a nitrogen atom. However, those having excessively strong basicity are not preferable because they may decompose organic resins, etc. Furthermore, the materials, which are Brönsted bases with respect to hydrogen in the organic resin constituting organic vehicle, reduce the viscosity immediately after production of the conductive paste due to the aforementioned functions and, therefore, are not desirable because they may cause defects, such as blurring, during the processing, such as printing.

As a consequence, regarding the conductive paste having a desired viscosity immediately after production, which increases with time, a material, which does not become a Brönsted base with respect to hydrogen in the contained organic resin constituting organic vehicle, and which has a Lewis base structure to supply an electron to the electron-deficient portion in the conductive powder, must be added. As the aforementioned material, a compound having a heterocyclic structure including nitrogen is most desirable.

Examples of compounds having a heterocyclic structure including nitrogen, which can be preferably used for the present invention, include, for example, benzotriazole represented by the following Chemical formula 2, and in addition to this, quinoline, isoquinoline, carbazole, indole, 1,8-diazaphenanthrene, etc. In order to sufficiently exhibit the aforementioned effects, the contents of theses additives are preferably 0.05 to 10 parts by weight, and more preferably, are 0.1 to 3 parts by weight relative to 100 parts by weight of the total of the conductive powder and the organic vehicle.

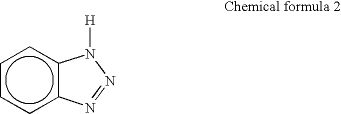

The compound having a heterocyclic structure including nitrogen, which is added into the conductive paste, must be a compound including no sulfur atom, and must be a compound which is dissolved into the solvent used for the conductive paste.

When the sulfur atom is included in the added material, in the electronic component including the electrode formed by using the conductive paste, the sulfur atom flows or diffuses into an element portion, for example, ceramic, from the electrode and, therefore, the characteristics of the electronic component vary remarkably.

When the added material does not dissolve into the solvent used for the conductive paste, solid matter other than the conductive powder will be present in the conductive paste. Consequently, when electrodes are formed by using such a conductive paste, many short-circuit defects may occur in the electronic components so as to bring about reduction in the yield.

The method for manufacturing the conductive paste according to the present invention (for example, the order of the compounding of each component and the method for kneading) is not specifically limited, and various methods can be used. However, in consideration of the functions and effects of the aforementioned additives, the conductive paste according to the present invention desirably contains both kinds of additives.

The method for forming the electrode of the electronic component by using the conductive paste according to the present invention is not specifically limited. However, from the viewpoint of miniaturization and reduction of the layer thickness of a lamination type electronic component, etc., examples of suitable methods include a method in which the conductive paste is precisely applied by a screen printing method with high printing precision, and thereafter, the organic vehicle is evaporated and decomposed by heating so as to form the electrode.

Furthermore, since the thickness of the electrode of the electronic component can be reduced to 1 mm or less by using the conductive paste according to the present invention, remarkably miniaturized and high-performance electronic components can be produced at high yields compared to conventional electronic components.

### EXAMPLES

The features of the present invention will be described below in detail by using Examples according to the present invention.

### Example 1

Twenty parts by weight of ethyl cellulose resin were added to 80 parts by weight of terpineol, and the resulting mixture was mixed with an agitator and, thereby, an organic vehicle was produced.

Fifty parts by weight of organic vehicle and 50 parts by weight of commercially available conductive powder made of metal powder and having a particle diameter of 0.1 mm were mixed and were uniformly dispersed with a triple roller mill and, thereby, a primary paste was produced.

One hundred parts by weight of the primary paste produced as described above and 1 part by weight of N,N′,N′-tris(2-hydroxyethyl)-N-alkyl-1,3-diaminopropane as a material, which has a tertiary amine structure and which is dissolved into the aforementioned organic vehicle, were mixed and, therefore, a conductive paste (Sample 1) was produced.

### Example 2

A primary paste was produced in a manner similar to that in the aforementioned Example 1. One hundred parts by weight of this primary paste and 1 part by weight of benzotriazole as a material, which has a heterocyclic structure including nitrogen but not including sulfur and which is dissolved into the organic vehicle, were mixed and, therefore, a conductive paste (Sample 2) was produced.

### Comparative Example

A primary paste was produced in a manner similar to that in the aforementioned Example 1, and was used as a conductive paste (Sample 3) without addition of specific additives or any further treatment.

Regarding the aforementioned Samples 1 to 3, the initial viscosity and the viscosity after 30 days of standing in the atmosphere at 25° C. were measured with an E type viscometer (manufactured by TOKIMEC INC.) under the conditions of 25° C. and 2.5 rpm. The results thereof are shown in Table 1.

TABLE 1

| | Initial | Viscosity |
|---|---|---|
| Sample | viscosity | after 30 days |
| 1 (Example 1) | 15 Pa · s | 14 Pa · s |
| 2 (Example 2) | 21 Pa · s | 22 Pa · s |
| 3 (Comparative example) | 23 Pa · s | 56 Pa · s |

As is clear from Table 1, regarding the conductive paste of Comparative example (Sample 3), the viscosity after standing for 30 days increases by a large degree, while regarding Sample 1 and Sample 2 of the Examples according to the present invention, increase in the viscosities are hardly observed even after standing for 30 days.

Furthermore, as is clear from Table 1, regarding the conductive paste of Example 2 (Sample 2), the viscosity equivalent to the initial viscosity of the conductive paste of Comparative example (Sample 3) is maintained even after standing for 30 days, and regarding the conductive paste of Example 1 (Sample 1), the initial viscosity is reduced compared to the initial viscosity of the conductive paste of Comparative example (Sample 3), and the viscosity (the initial viscosity) is maintained even after standing for 30 days.

As described above, by using the conductive paste stably having a desired viscosity according to the present invention, electrodes having a uniform and reduced thickness can be formed reliably and, therefore, remarkably miniaturized and high-performance electronic components can be produced at high yields compared to conventional electronic components.

The present invention is not limited to the aforementioned embodiments and examples. Regarding the kind and compounding ratio of the conductive powder, the kind and compounding ratio of the organic vehicle, the kind and amount of the additive added, and the kind of the electronic component produced by using the conductive paste according to the present invention, various applications and modifications are possible within the scope of the present invention.

As described above, regarding the conductive paste according to the present invention, in order to control the viscosity, at least one compound selected from the group consisting of a compound, which has a tertiary amine structure and which is dissolved into the organic vehicle, and a compound, which has a heterocyclic structure including nitrogen but not including sulfur and which is dissolved into the organic vehicle, is added (that is, when the viscosity immediately after production is high, the compound, which has a tertiary amine structure and which is dissolved into the organic vehicle, is added, and when the viscosity increases with time after production, the compound, which has a heterocyclic structure including nitrogen but not including sulfur and which is dissolved into the organic vehicle, is added), a conductive paste having a desired viscosity in response to the viscosity characteristics of the conductive paste can be produced, and in addition to this, the desired viscosity can be maintained for a long time.

Even when the viscosity required of the conductive paste is lower than the viscosity immediately after production (initial viscosity), by adding the aforementioned appropriate additives, the initial viscosity can be reduced, and this viscosity can be maintained for a long time.

According to the present invention, by having at least one compound selected from the group consisting of compounds, which have a tertiary amine structure and which are dissolved into the organic vehicle, in order to stabilize the viscosity, solid matter other than the conductive powder in the conductive paste become unlikely to occur. Therefore, when the electrode of the electronic component is formed by using the conductive paste according to the present invention, occurrence of short-circuit defects, etc., due to the solid matters other than the conductive powder can be prevented, and the yield of the product can be improved.

According to the present invention, since it is possible to make the conductive paste have a desired viscosity, the following effects are obtained: (1) the flexibility in choosing a method for forming the electrode of the electronic component can be improved; (2) by using printing techniques, for example, a screen printing method, the thickness of coating can be reduced to 1 mm or less, and variations of the thickness of coating and change in the thickness over time can be prevented so as to improve the rate of good items; and (3) since the viscosity changes less with time, and the conductive paste is preserved long-term, the batch size of production of the conductive paste can be increased and, therefore, the production cost can be reduced by a large degree.

Regarding the conductive paste according to the present invention, although the kind of conductive powder is not specifically limited, by using a conductive powder containing at least one selected from the material group consisting of Pt, Ag, Ni, Cu, Al, and W or an alloy including at least one selected from the aforementioned material group, an electrode having sufficient electrical conductivity can be formed reliably.

By using an organic vehicle containing at least one compound selected from the group consisting of compounds having a cellulose structure, compounds having a cellulose ester structure, and compounds having a cellulose ether structure, since the viscosity required for the coating can be ensured with the organic vehicle at a reduced content, the content of the conductive powder in the conductive paste can be increased.

Since the electronic component according to the present invention is provided with the electrode, which is formed by using the conductive paste according to the present invention, and which has a uniform and reduced thickness, a miniaturized electronic component having high performance and high reliability can be provided.

When the electrode is formed by printing the conductive paste according to the present invention and heating, the electrode having a uniform and reduced thickness can be formed with ease and reliability and, therefore, a miniaturized electronic component having high performance and high reliability can be produced without especially complicated steps for manufacturing.

When the thickness of the electrode to be formed is reduced to 1 mm or less, it is especially required to use a conductive paste having a desired viscosity. However, when the electrode is formed by using the conductive paste according to the present invention, an electronic component provided with the electrode having the thickness of the primary part of 1 mm or less can be reliably produced.

The monolithic ceramic capacitor is an electronic component, in which, especially, the number of laminated layers of internal electrodes and ceramic layers must be increased in order to meet the demands for miniaturization and large capacitance. However, when the electrode is formed by using the conductive paste according to the present invention, a miniaturized monolithic ceramic capacitor having large capacitance and high reliability can be produced, in which the electrode has a reduced and uniform thickness, and defects, such as delamination, are unlikely to accompany the increase in the number of the laminated layers.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed:

1. A conductive paste comprising:
(a) a conductive powder;
(b) an organic vehicle; and
(c) at least one compound which has a heterocyclic structure including nitrogen but not including sulfur and which can be dissolved into the organic vehicle.

2. The conductive paste according to claim 2, wherein the compound which has a heterocyclic structure including nitrogen but not including sulfur and which can be dissolved into the organic vehicle is at least one compound selected from the group consisting of benzotriazole, quinoline, isoquinoline, carbazole, indole, and 1,8-diazaphenanthrene.

3. The conductive paste according to claim 1, wherein the conductive powder comprises at least one material selected from the material group consisting of Pt, Ag, Ni, Cu, Al and W or an alloy including at least one material selected from the material group.

4. The conductive paste according to claim 1, wherein the organic vehicle comprises at least one resin compound selected from the group consisting of compounds having a cellulose structure, compounds having a cellulose ester structure, and compounds having a cellulose ether structure.

5. The conductive paste according to claim 5, wherein the compound which has a heterocyclic structure including nitrogen but not including sulfur and which can be dissolved into the organic vehicle is at least one compound selected from the group consisting of benzotriazole, quinoline, isoquinoline, carbazole, indole, and 1,8-diazaphenanthrene.

6. The conductive paste according to claim 5, wherein the conductive powder comprises at least one material selected from the material group consisting of Pt, Ag, Ni, Cu, Al, and W or an alloy including at least one material selected from the material group.

7. The conductive paste according to claim 1, wherein the conductive powder comprises at least one material selected from the material group consisting of Pt, Ag, Ni, Cu, Al, and W or an alloy including at least one material selected from the material group.

8. An electronic component comprising an electrode formed by using conductive paste according to claim 6.

9. An electronic component comprising an electrode formed by using conductive paste according to claim 2.

10. An electronic component comprising an electrode formed by using conductive paste according to claim 1.

11. An electronic component comprising an electrode formed by printing the conductive paste according to claim 1.

12. The electronic component according to claim 11, wherein the thickness of a primary part of the electrode is 1 mm or less.

13. The electronic component according to claim 11, wherein the electronic component is a monolithic ceramic capacitor.

14. An electronic component comprising an electrode formed by printing the conductive paste according to claim 2.

15. An electronic component comprising an electrode formed by printing the conductive paste according to claim 6.

16. A method of controlling the viscosity of a conductive paste including a conductive powder and an organic vehicle, which comprises:
adding to the conductive paste at least one compound which has a heterocyclic structure including nitrogen but not including sulfur and which can be dissolved into the organic vehicle.

17. A method of controlling the viscosity of a conductive paste according to claim 16, wherein the compound which has a heterocyclic structure including nitrogen but not including sulfur and which can be dissolved into the organic vehicle is at least one compound selected from the group consisting of benzotriazole, quinoline, isoquinoline, carbazole, indole, and 1,8-diazaphenanthrene.

18. A method of controlling the viscosity of a conductive paste according to claim 17, wherein the conductive powder comprises at least one material selected from the material group consisting of Pt, Ag, Ni, Cu, Al, and W or an alloy including at least one material selected from the material group.

19. A method of controlling the viscosity of a conductive paste according to claim 18, wherein the organic vehicle comprises at least one resin compound selected from the group consisting of compounds having a cellulose structure, compounds having a cellulose ester structure, and compounds having a cellulose ether structure.
